(19) United States
(12) Patent Application Publication
(10) Pub. No.: US 2010/0150767 A1
(43) Pub. Date: Jun. 17, 2010

(54) Method of making metallic foams and foams produced

(75) Inventors: David C. Dunand, Evanston, IL (US); Ampika Bansiddhi, Evanston, IL (US)

Correspondence Address: Mr. Edward J. Timmer, Suite 205, 121 East Front Street, Traverse City, MI, 49684, US

(73) Assignee: Northwestern University

(21) Appl. No.: 12/590,992

(22) Filed: Nov. 17, 2009

Related U.S. Application Data
(60) Provisional application No. 61/199,461, filed on Nov. 17, 2008.

(51) Int. Cl. B22F 3/11; B22F 1/00; B32B 15/02; B32B 5/18

(52) U.S. Cl. 419/2; 75/228

(57) ABSTRACT

A method of making a metallic foam by a sintering process that includes solid state sintering and transient liquid phase sintering to form and then densify the metallic foam structure. A metallic foam is provided having a sintered foam skeleton structure with desirable macro-pores throughout wherein the undesirable micropores in walls of the skeleton structure are filled by a eutectic phase without closing off the desirable macro-pores.

This application claims benefits and priority of provisional application Ser. No. 61/199,461 filed Nov. 17, 2008, the disclosure of which is incorporated herein by reference.

### CONTRACTUAL ORIGIN OF THE INVENTION

This invention was made with government support under Grant No. DMR 0505772 awarded by the National Science Foundation. The Government has certain rights in the invention.

### FIELD OF THE INVENTION

The present invention relates to metallic foams and to a method for making a metallic foam by a sintering process that includes solid state sintering and transient liquid phase sintering to form and then densify the foam wall structure.

### BACKGROUND OF THE INVENTION

NiTi foams are used for multifunctional applications in aerospace and automotive areas, medical implants, and actuators. The NiTi foam comprises NiTi alloy regions (called strut regions) and void regions.

Manufacture of NiTi foams with high melting point (1310° C.) by liquid phase processes is difficult as a result of high chemical reactivity of molten NiTi and susceptibility to processing environments and contamination. Manufacture of NiTi foams often is conducted using powder metallurgy (PM). However, due to the nature of the near equiatomic composition of NiTi (which is a near-line compound, with very little solubility for Ni or Ti away from the near equiatomic composition), the composition of NiTi needs to be strictly controlled to maintain the NiTi phase responsible for the shape memory effect and superelasticity useful for above applications.

Process strategies to produce macro-porosity in NiTi foams have relied on residual porosity from initial green powder compact porosity, porosity caused by added pore-forming agents or trapped argon gas during PM process, and/or porosity created by space-holder materials mixed together with metallic powders into a compact and removed before, during or after the PM densification process. The space holder method allows for independent control of pore size, shape and volume fraction, since these are directly controlled by the space-holder particles. The other process strategies to produce macro-pores are dependent on the NiTi powder itself, or the choice of processing parameters, and cannot offer a tailor-made porous structure.

Although PM techniques are known for providing good densification, densification of the high temperature NiTi powders surrounded by large space-holders cannot be achieved without pressure-assisted or lengthy sintering process, especially when pre-alloyed NiTi powders are used where only solid state diffusion bonding is the main mechanism for densification. This insufficient densification in the NiTi strut regions provides weak points for fatigue fracture and crack initiation of the macro-porous foam material, which is undesirable especially in load-bearing applications.

### SUMMARY OF THE INVENTION

The present invention involves making a metallic foam by a sintering process that includes solid state sintering and transient liquid phase sintering to form and then densify the wall structure of the metallic foam.

In an illustrative embodiment of the invention, the method involves forming a compact comprising a first region which comprises intermixed metallic (e.g. NiTi) particles and space-holder particles and an adjacent second region which comprises intermixed metallic particles and eutectic phase-forming particles, heating the compact at a first elevated solid state sintering temperature to form a metallic foam material having a sintered foam skeleton structure with walls surrounding pores formed by selective removal of the space-holder particles, and heating the metallic foam material at a second higher elevated temperature above a melting temperature of a eutectic phase formable between the metallic (e.g. NiTi) particles and the eutectic phase-forming particles so as to form a liquid eutectic phase that wicks into micro-pores of walls of the foam skeleton structure to densify them without closing off macro-pores of the foam structure.

In another illustrative embodiment of the invention, the method involves forming a compact comprising intermixed first metallic particles and second metallic particles that function as space-holder particles and as a eutectic phase-forming agent and sintering the compact in a manner to form a foam skeleton structure and a transient liquid phase which densifies walls of the foam skeleton structure without closing off relatively large pores thereof.

In practice of the invention, solid state sintering followed by transient liquid phase sintering can occur during heating of the metallic particles to suitable elevated sintering temperature in multiple heating stages with hold times and/or by using a controlled heating rate to this end.

The present invention thus envisions a metallic foam having a sintered foam skeleton structure comprising walls connected at nodes with macro-pores throughout wherein the skeleton wall structure itself is densified by a eutectic phase wicked into micro-pores thereof without closing off the macro-pores.

The present invention can be practiced, but is not limited to, making porous metallic foams comprising the near-equiatomic NiTi alloy (either shape memory or superelastic alloys) wherein the NiTi foam skeleton structure is densified with a eutectic phase comprising Ni, Ti, and Nb.

Other advantages and features of the present invention will become more readily apparent from the following detailed description taken with the following drawings.

### BRIEF DESCRIPTION OF THE DRAWINGS

FIG. 1 is a flow diagram of a double-layer method embodiment of the invention.

FIG. 2a is an optical photomicrograph of a NiTi metallic foam in the as-sintered condition made using a conventional sintering process wherein the foam skeleton comprises sintered NiTi particles with undesirable micro-pores or voids.

FIG. 2b is an optical photomicrograph of a NiTi metallic foam cross-section in the as-sintered condition made using the double-layer method embodiment of the invention shown in FIG. 1.

FIG. 2c is a higher magnification optical photomicrograph of a NiTi foam cross-section confirming the densification of the NiTi wall or strut regions and elimination of the undesirable micro-pores and open macro-pores produced by selective removal of the fugitive space-holding NaCl particles.

FIG. 2d shows a vertical cross-section showing full infiltration throughout Ni-rich NiTi foam produced by the double-layer method embodiment of the invention pursuant to FIG. 1.

FIG. 3 is a binary phase diagram of Ni and Nb.

FIG. 4a is an optical photomicrograph of a NiTi metallic foam cross-section in the as-sintered condition (1185° C. for 10 hours) made using the method embodiment with Nb addition described in Example 2.

FIG. 4b is an optical photomicrograph of a NiTi metallic foam cross-section in the as-sintered condition made using a conventional sintering process (without Nb addition) at 1250° C. for 10 hours.

FIGS. 4c and 4d are stress-strain behaviors of the NiTi foams shown in FIG. 4a and FIG. 4b, respectively.

FIG. 4e is a DSC (differential scanning calorimetric) curve of NiTi foam produced by transient liquid phase sintering (with Nb addition) at 1185° C. for 10 hours. The vertical dash line represents room temperature. Aₛ, A_{f} and Mₛ,M_{f} are austenite and martensite transformation temperatures, respectively.

FIG. 5 is an SEM (scanning electron micrograph) image of NiTi foam cross-section produced by transient liquid phase sintering with Nb space-holders in the form of chopped wires.

FIG. 6 is an optical photomicrograph at high magnification of NiTi foam cross-section (pores are black and NiTi metallic foam skeleton in gray) produced by Example 3.

FIG. 7 is a DSC curve of NiTi foam produced by sintering with Nb chopped wire lengths by heating to and holding at 1185° C. for 10 hours of Example 3. The vertical dash line represents room temperature. Aₛ, A_{f} and Mₛ,M_{f} are austenite and martensite transformation temperatures, respectively.

### DESCRIPTION OF THE INVENTION

An illustrative embodiment of the present invention involves making a metallic foam by sintering metallic particles, such as powder particles, to form a metallic foam and then to form a transient liquid phase which densifies the foam skeleton structure without closing off relatively large (macro) pores thereof. The invention provides in a particular illustrative embodiment a method for producing superelastic macro-porous NiTi material in a tailored sintering process with separate control of NiTi densification level and the overall macro-porous foam structure, although the invention is not limited to producing superelastic porous NiTi material and can be used to make other porous alloy or metal foam materials. Other metallic foams can be produced including, but not limited to, Ti—Al with Fe and other foams.

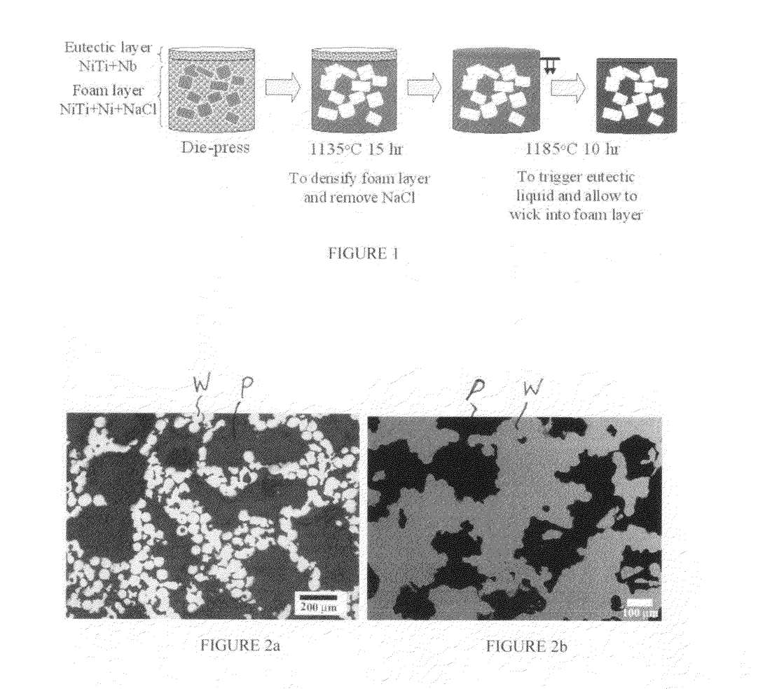

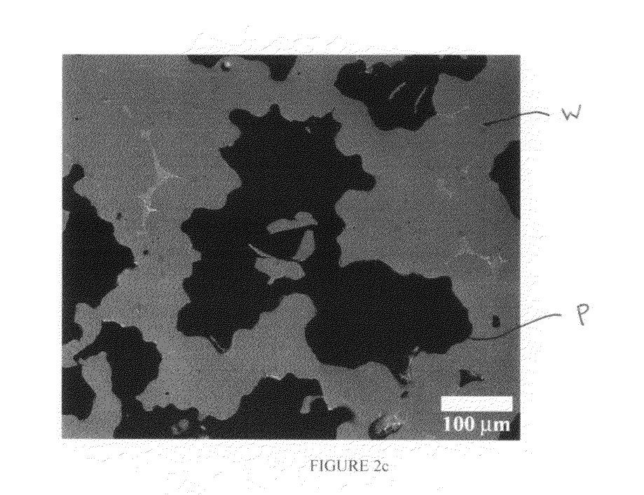

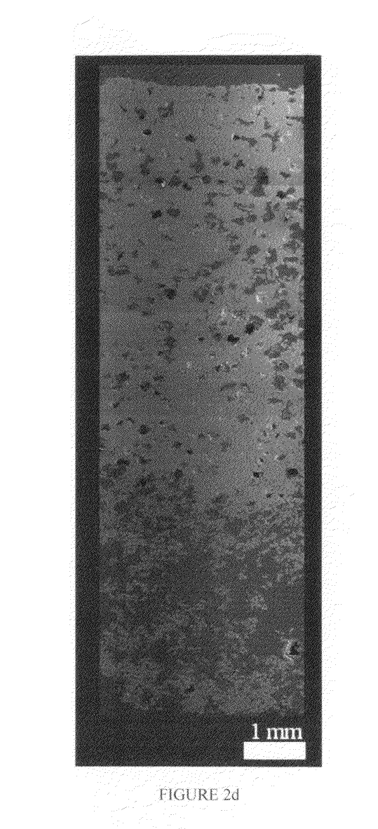

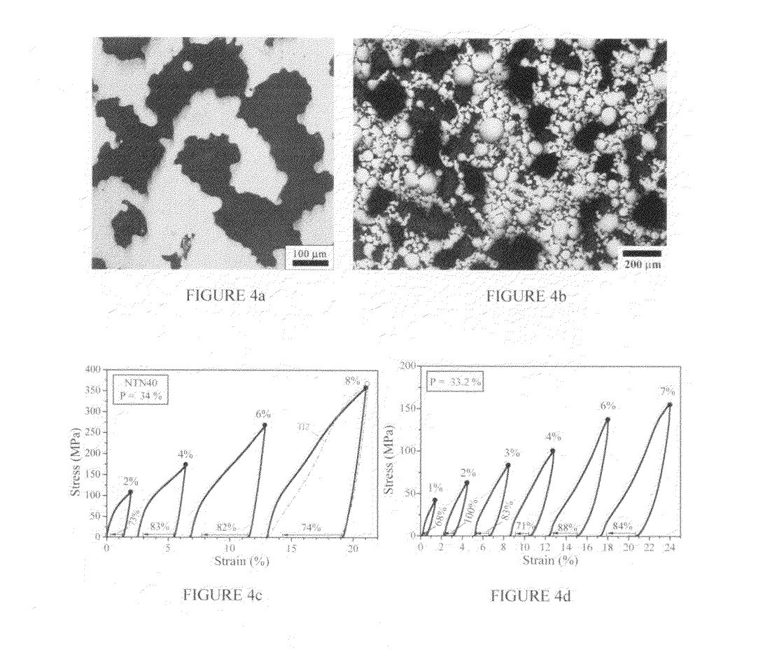

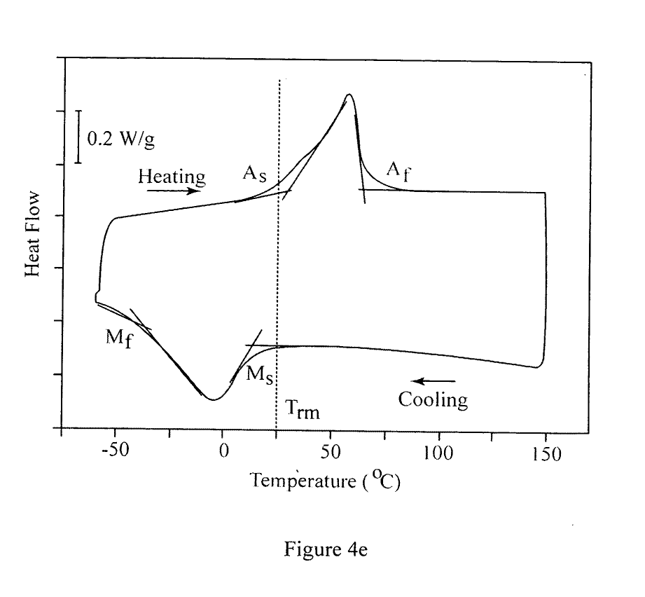

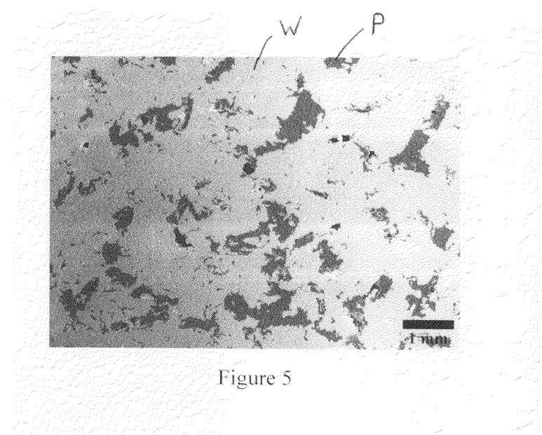

An embodiment of the method of the invention involves sintering metallic powder particles at a first elevated temperature that is above a solid state sintering temperature of the metallic powder particles to form a metallic foam material having a sintered metallic skeleton structure comprised of sintered metallic particles forming a wall structure having micropores and surrounding the macro-pores and then followed by transient liquid phase sintering of the metallic foam material at a second higher elevated temperature than the first temperature to form a transient liquid phase that wicks into micro-pores or voids of walls of the sintered metallic skeleton structure to densify it without closing off the macro-pores. Solid state sintering followed by transient liquid phase sintering can occur during heating of the metallic particles to suitable elevated sintering temperatures in multiple heating stages with hold times and/or by using a controlled heating rate to this end. For purposes of illustration, an undensified sintered foam skeleton structure comprised of solid state sintered metallic powder particles forming walls surrounding macro-pores resembles that shown in FIGS. 2a and 4b produced by a conventional sintering process without Nb addition.

The invention is advantageous in that the sintering treatment can be performed on metallic foam skeleton structures which comprise solid state sintered metallic particles forming a foam wall structure and which include a high fraction of interconnected large smacro-pores; for example, large pores having a major dimension in the range of 0.05 mm to 5 mm to provide a foam porosity in the range of 20% to 80%. Infiltration of the transient liquid phase into micro-pores of the undensified foam wall structure (matrix) is achieved without filling of the larger macro-pores of the foam skeleton structure with the transient liquid phase by appropriate selection of system components such as NiTi—Nb. This advantage of the invention may be exploited in other metallic systems of technical interest, allowing good densification of powder particles in a foam using low temperatures, and without destroying larger pores created earlier in the process (for example by evaporated space-holder particles). This is particularly useful for pure metals, alloys, and intermetallic compounds (near line compound alloys) which need a tightly controlled composition.

The present invention provides in another embodiment a metallic foam having a sintered metallic foam skeleton structure forming a foam wall structure or matrix in which macro-pores are present throughout, wherein the skeleton structure comprises walls which surround the macropores and which are densified by a eutectic phase wicked into micro-pores thereof without closing off the macro-pores of the foam skeleton structure. The walls of the foam skeleton structure surrounding the macropores can comprise wall regions that have a sheet-like morphology or so-called strut regions which are more elongated in shape, the terms wall regions and strut regions being used interchangeably herein. For purposes of illustration and not limitation, practice of the invention allows obtainment of high densification (reduced microporosity) in NiTi walls of the NiTi foam, while maintaining desired macroporosity in the NiTi foam and also lowering cost of production as well as allowing flexibility in processing routes. Such metallic foams made of high-melting alloys characterized as a near line compound (such as NiTi) can be used for structural, load-bearing applications, as energy absorber, sound absorber, filter, heat exchanger, gas diffuser (for fuel cells) or as bone implant applications.

### Example 1

This Example is offered to illustrate a so-called double-layer method embodiment of the invention that comprises (i) mixing pre-alloyed NiTi powders (with or without Ni addition) and inert space-holder powders (such as a salt) as a first layer region of a compact; (ii) mixing a transient (eutectic) liquid phase sintering agent with the pre-alloyed NiTi powders as a second layer region, which is then pressed on top of the first layer region to provide a single compact; (iii) sintering under vacuum this single compact at a temperature below the eutectic temperature to partially sinter NiTi powders into a skeleton structure while the space-holder powders are removed by evaporation, leaving desired macro-porosity in the NiTi foam skeleton structure which also contains undesirable microporosity; (iv) heating the compact at a higher second temperature above the eutectic temperature to create a transient liquid eutectic phase which wicks into the microporosity of the previously formed NiTi foam structure to enhance densification of NiTi wall and/or strut regions and remove its microporosity.

The use of pre-alloyed NiTi powders to produce NiTi foams in this Example allows for uniform composition and avoids contamination often observed in NiTi foams produced from elemental Ni and Ti powders, although pure metallic powders can be used in practice of the invention. To create superelastic NiTi foams with desired Ni-rich composition, addition of Ni powders to pre-alloyed NiTi powder is employed. NiTi powders can have a particle size in the range of 0.01-0.5 mm. Ni powder can have a particle size in the range of 0.001-0.1 mm for purposes of illustration and not limitation.

In this Example, space-holder salt particles, such as NaCl particles, were chosen due to the following advantages.
the salt is chemically unreactive with the metal (in fact, most alkali metal and alkaline-earth metals halides are unreactive with respect to most transition metals).
the salt does not dissociate in gaseous products (such as some carbonates do) or liquid/solid products that react with the metal.
the salt does not dissolve appreciably the metal with which it is in contact.
the salt does not dissolve appreciably into the metal, (e.g. by decomposition and diffusion of the atomic species).
the salt is removable by vacuum evaporation or dissolution in water.

NaCl particles can have particle size in the range of 0.005-1 mm for purposes of illustration and not limitation.

In this Example, pure niobium (Nb) was chosen as a transient liquid phase-forming agent for the following advantage:
NiTi—Nb system offers reactive eutectic sintering with NiTi at 1170° C. (140° C. below the melting point of NiTi)
NiTi—Nb system has terminal phases with low mutual solubility. Therefore, Nb is a good candidate to perform transient liquid sintering, creating a permanent connection between NiTi powders, while causing only slight changes in NiTi fraction (responsible for shape memory effect and superelasticity).
No reaction between Nb and NaCl is expected.
Nb and NiTi—Nb alloy exhibits excellent biocompatibility and is non-toxic in tissue interaction (in case of biomedical applications).

Since Ni and Nb can form stable Ni—Nb phases at low temperature and interaction between Ni and Nb is undesirable, the method was designed in a way that Nb and Ni are separated physically and functionally. Instead of making a single preform of NiTi, Ni and Nb powders, two layers were made and stacked one on top of the other. Nb is used in the eutectic forming layer (top) where NiTi and Nb were mixed at eutectic composition; while Ni is used only in the Ni-rich NiTi foam mixture layer (bottom). Ni is used here in small quantities to modify the Ni/Ti ratio of the near-equiatornic NiTi, and change its mechanical properties (achieve superelasticity at ambient temperature).

A duplex sintering treatment was carried out as follows:

1) a first sintering treatment stage was conducted below the eutectic temperature of Nb—NiTi to activate solid state interdiffusion between NiTi powders and Ni diffusion into NiTi in the bottom layer to form Ni-rich NiTi composition, while NaCl is evaporated to create a macro-porous structure. The diffusion was allowed for long enough time to ensure a strong and homogeneous Ni-rich NiTi sintered foam structure.
2) a second sintering treatment stage was conducted above the eutectic temperature (1170° C.) to activate Nb—NiTi liquid eutectic formation in the top layer. Since Nb in the eutectic top layer is chemically stable and Nb diffusion into NiTi is slow, solidification of the transient liquid relies on process control (i.e., cooling) rather than diffusion between Nb and NiTi. The eutectic liquid tends to wick into the open porous foam skeleton structure, aided by gravity. At the same time, capillary forces in the small microporosity channels between Ni-rich NiTi particles keep the transient liquid within the metal walls/struts, preventing spilling into, and filling of, the macropores.

To create a Ni-rich NiTi foam with high densification throughout a desired foam dimension, some processing factors are taken into account. For instance, in the eutectic liquid layer, a sufficient amount of eutectic liquid and sufficiently high temperature (to ensure sufficient liquid formed) are considered. In Ni-rich NiTi foam layer, sufficient particle packing leading to small microporosity and thus high capillary forces, accelerating the wicking process, can be employed.

This Example employed pre-alloyed equiatomic NiTi powders and a small addition of Ni powder, resulting in a NiTi foam with about 40% porosity. Such shape-memory foams would be useful for biomedical implants (the porosity favors bone ingrowth) and for actuators (the porosity increases the heat-transfer between the metal and air, decreasing response times).

The Example comprised the specific steps of: (i) making a Ni-rich NiTi foam mixture by mixing Nb-free, near-equiatomic (48.6 at. % Ni) NiTi powders having a sieved particle size range of 44-63 μm and Ni powders (2.2 at. %) having a particle size of 3-7 μm with 40 vol. % NaCl cuboidal-shaped powders having a sieved particle size range of 100-250 μm; (ii) creating a NiTi-26 at. % Nb eutectic mixture by mixing appropriate amounts of near-equiatomic NiTi powders and Nb powders with the proportion of Nb (in the eutectic mixture) to overall NiTi (in both the eutectic and foam mixtures) being 6 at % Nb; (iii) forming a double-layer pellet (1.25 cm in diameter, 1.2 cm in height) via cold pressing: packing the NiTi+Ni+NaCl powder mixture in 1.25 cm die, adding a layer of the NiTi—Nb eutectic powder mixture on top, and then cold-pressing together the two layers at 350 MPa pressure to form a two-layered compact; (iv) heating the compact in a high vacuum tube furnace in two sintering stages: at 1135° C. for 15 hours (solid state sintering below eutectic 1170° C. temperature), and at 1185° C. for 10 hours (transient liquid phase sintering above eutectic 1170° C. temperature) before furnace-cooling down to room temperature at a rate of 7° C. per minute. The method scheme of this Example is shown in FIG. 1.

For comparison, a conventional sintering method for Ni-rich NiTi—Nb foams was also conducted as now described. In particular, a NiTi—Ni mixture was blended for 2 hours to ensure a homogeneous distribution of Ni powders, before direct adding the Nb powders (in a ratio of 6 at. % Nb to 94 at. % NiTi in the mixture) and blending for an additional 2 hours. The NiTi—Ni—Nb mixture was then blended with NaCl powder with a volume ratio of 3 to 2. The control or comparison pellet of NiTi—Ni—Nb—NaCl was sintered at 1185° C. (above eutectic 1170° C. temperature) for 10 hours. Powder particles sizes were the same as or similar to those used in the double-layer method.

In both experiments, the sintering temperature was above the melting temperature of the NaCl powders leading to existence of molten salt during the process. The NaCl space-holding particles were removed by evaporation leaving empty spaces behind as macro-pores in NiTi mixture network or skeleton. The resulting porous NiTi foam network or skeleton (see FIGS. 2a and 2b) provides interconnected porous structure without the evidence of reaction between the NaCl and NiTi or Nb. The porosity is about 40%, the pore shape is rectangular (reflecting the NaCl pore shape) and the pore size is in the range of 0.1-0.4 mm as preferred for example in bone replacement. These pore characteristics can be controlled by the amount, shape and size of NaCl, respectively.

FIGS. 2a and 2b offer a comparison of micrographs of NiTi foams (macropores P are dark or black, metallic walls W are lighter) in the as-sintered condition. FIG. 2a shows the sintered NiTi foam having sintered particle walls W produced by the conventional sintering approach. FIG. 2b shows the sintered NiTi foam produced by the duplex sintering treatment pursuant to an embodiment of the invention. Individual spherical NiTi particles with micropores are still visible due to incomplete densification in FIG. 2a, while NiTi wall or strut regions are well-densified and micropores have disappeared in FIGS. 2b and 2c by wicking of the liquid eutectic phase therein, while maintaining the desirable macropores P. The blocky shape of the NaCl particles is replicated as macropores in both cases, indicating that a sufficiently strong NiTi network was formed before NaCl evaporation in both cases to prevent collapse. FIG. 2c is a higher magnification micrograph of a NiTi foam of FIG. 2b confirming the densification of the NiTi walls W and open macropores P produced by selective removal of the fugitive space-holding NaCl particles.

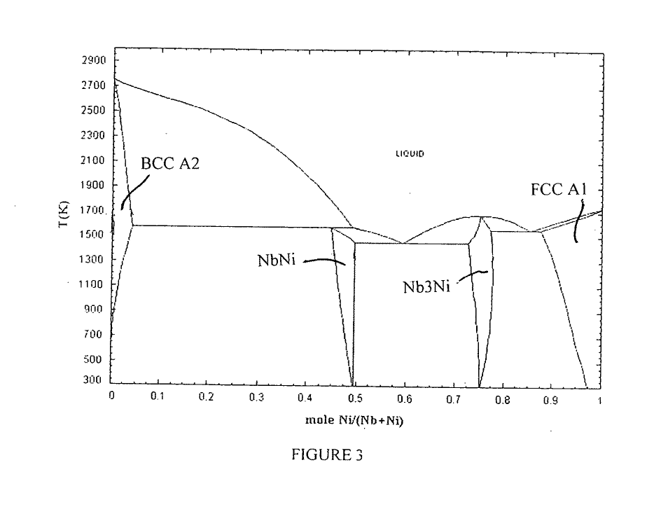

A main difference in these two foam structures is the degree of densification of the NiTi walls W which directly affects their mechanical and fatigue behavior. In the conventional sintering of NiTi—Ni—Nb—NaCl mixtures, Ni tends to form an intermetallic compound with Nb (NiNb and Ni₃Nb seen in Ni—Nb phase diagram in FIG. 3) which are stable at low temperature and thus prevent the activation of the eutectic liquid phase between Nb and NiTi. Therefore, poor densification in NiTi walls is observed in FIG. 2a. In contrast, by physical and functional separation of Nb (in the top liquid layer) and Ni (in the bottom foam mixture layer) in the method embodiment of the invention, Nb is allowed to form eutectic liquid with NiTi before entering the foam layer where Ni-rich composition exists, resulting in densification of the walls W, FIG. 2b.

The combination of material selection (i.e. particle size of NiTi and Nb content) and processing choices (i.e. temperature, time) permit an appropriate amount of eutectic liquid layer forming at the operating temperature (1185° C.) and strong capillary forces between powder mixture in the foam layer in order to drive the eutectic liquid phase from the top layer to infiltrate the microporosity and densify NiTi walls in the lower layer without closing the macropores obtained by the removal of NaCl space-holding particles. The low diffusivity of Nb in NiTi prevents dissolution of the foam layer at the interface with the liquid eutectic layer and allows the eutectic liquid to wick through the foam layer without termination by dissolution of Nb in NiTi. Rather, the wicking depth of the liquid is mainly controlled by process parameters. High densification of NiTi struts was carried out to 0.8 cm depth (from 1.2 cm sample size). Further activity of the liquid phase could be achieved by adjusting temperature, viscosity and amount of eutectic liquid phase and surface tension between NiTi powders to achieve full walls densification and larger size of Ni-rich NiTi foam.

For example, full densification of wall and strut regions throughout the entire volume of Ni-rich NiTi foam was achieved by adjusting processing parameters in the double-layer method. FIG. 2d shows full infiltration of eutectic liquid throughout 8 mm-tall NiTi (50.8 at. % NiTi) foam. The following parameters were adjusted; namely, a higher amount of eutectic liquid (8 wt. % Nb vs. 6 wt. % Nb of total NiTi foam volume), higher volume fraction of NaCl space-holder (60 vol. % vs. 40 vol. %) affecting powder packing, and higher sintering temperature (1195° C. vs. 1185° C.) to reduce liquid viscosity. A region 2-3 mm deep from top of the sample contains solidified residual liquid was found and can be removed after the process.

### Example 2

This Example is offered to illustrate fabrication of NiTi foam using NaCl powder particles as spaceholder particles (pore forming agent) and Nb powder particles as densification enhancer (eutectic liquid forming agent) using a controlled heating rate to achieve solid state sintering followed by a hold at a transient liquid phase sintering stage.

In this Example, shape-memory NiTi foams were produced by sintering of a NiTi—Nb—NaCl powder mixture pellet at 1185° C. for 10 hours with a heating rate of 7° C./min and then furnace cooled to room temperature. Prealloyed NiTi, Nb and NaCl powders used in the mixture were from the same batch and the sintering process was conducted in the same high vacuum furnace as in Example 1 with Nb powders having a particle size of 1-5 μm. The ratio of NiTi to NaCl was 3 to 2 by volume and the Nb addition was about 5.3 wt %. Unlike Example 1, all powders were mixed together without separating into double layers since Ni, reactive with Nb, was not added. High densification of NiTi strut regions were produced as observed in FIG. 4a due to the formation of NiTi—Nb eutectic liquid and in-situ transient liquid phase sintering within NiTi strut regions. The eutectic appears to comprise a matrix with a composition close to NiTi and Nb-rich discontinuous phase, which can be elongated or blocky, in the matrix.

In comparison, the microstructure of a NiTi (50.8 at. % Ni) foam, without Nb addition, produced by conventional sintering at 1250° C. (65° C. higher than that used above for 10 hours (same processing time), is shown in FIG. 4b, and has poorer densification.

The mechanical behaviors of both NiTi foams, with similar porosity, displayed in FIGS. 4a and 4b demonstrate that higher densification in NiTi strut or wall regions of FIG. 4a translates in higher strength NiTi foam while high ductility and high recovery strain is maintained. The mechanical behavior for the NiTi foam of FIG. 4a produced pursuant to the invention is shown in FIG. 4c. The mechanical behavior for the NiTi foam of FIG. 4b produced by conventional sintering is shown in FIG. 4d.

FIG. 4e shows the phase transformation behavior for the NiTi foam of FIG. 4a pursuant to the invention where the observed DSC curve confirms transformation temperature range needed for shape memory effect at room temperature of the NiTi foam even though slight amount of Nb was added.

### Example 3

This Example is offered to illustrate fabrication of NiTi foam by using Nb chopped (discontinuous) wire lengths as both spaceholder particles (pore forming agent) and densification enhancer (eutectic liquid forming agent) using a controlled heating rate to achieve solid state sintering followed by a hold at a transient liquid phase sintering stage.

In particular, Nb chopped wires of 0.125 mm diameter and 0.5-1 mm long were mixed with prealloyed NiTi powder in the ratio of 5.3 wt. % Nb to 94.7 at. % NiTi. The powder/chopped wire mixture was die pressed with a pressure of 350 MPa into 12.7-mm diameter and 8 mm-tall pellet. The pellet was sintered in a high vacuum furnace at 1185° C. for 10 hours with a heating rate of 7° C./min and then furnace cooled to room temperature. The resulting microstructure of the NiTi foam (FIG. 5) reveals porosity of 30% with macropores with 250-500 μm size and some micropores with 5-10 μm size. Macropores were produced by the disappearance of Nb wires space-holder at above eutectic temperature (1170° C.) to participate in eutectic reaction with surrounding NiTi before wicking into micro-channels. The residual micropores can be reduced by increasing sintering time and/or amount of Nb chopped wires in order to allow full liquid infiltration.

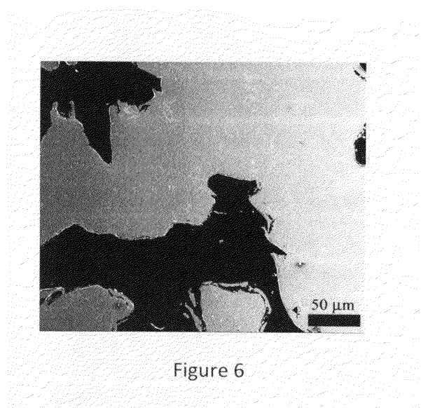

FIG. 6 shows the NiTi foam produced using the Nb chopped wire lengths as space-holder particulates and as a eutectic phase-forming agent in this Example and confirms that the NiTi wall or strut regions (gray features) of the foam skeleton structure were substantially fully densified while macro-pores (black pores) were formed by melting of the Nb chopped wire lengths.

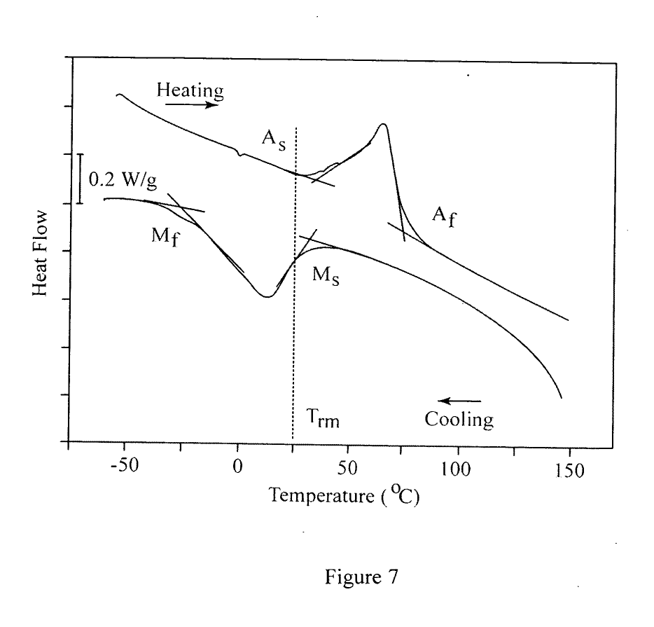

The phase transformation behavior observed for the NiTi foam of this Example shown in the DSC curve of FIG. 7 is such that shape memory effect at room temperature may be observed.

Although the invention has been described in detail above with respect to certains illustrative embodiments thereof, those skilled in the art will appreciate that modifications and changes can be made therein within the spirit and scope of the invention as set forth in the pending claims.

1. A method of making a metallic foam material, comprising sintering metallic particles to form a metallic foam with a foam skeleton structure and a transient liquid phase which densifies walls of the foam skeleton structure without closing off pores thereof.

2. The method of claim 1 wherein solid state sintering is followed by transient liquid phase sintering during heating of the metallic particles to elevated sintering temperature in multiple heating stages and/or using a controlled heating rate.

3. The method of claim 2 wherein solid state sintering is achieved by a controlled heating rate and transient liquid phase sintering is achieved by a hold time at a transient liquid phase sintering temperature.

4. The method of claim 1 wherein a mixture of the metallic particles and fugitive space-holder particles are sintered such that the space-holder particles are selectively removed to form the pores in the skeleton structure.

5. The method of claim 1 wherein a mixture of the first metallic particles and second metallic particles are sintered such that the second metallic particles participate in formation of the transient liquid phase and leave pores in the skeleton structure.

6. The method of claim 1 wherein the metallic particles comprise pre-alloyed powders or pure metallic powders.

7. The method of claim 1 wherein the metallic particles have a particle size in the range of 0.01 to 0.5 mm.

8. The method of claim 1 wherein the metallic particles comprise pre-alloyed NiTi powder particles and the transient liquid phase-forming agent comprises Nb.

9. A method of making a metallic foam material, comprising:
a) forming a compact comprising a first region comprising intermixed metallic particles and space-holder particles and a second region comprising intermixed metallic particles and eutectic phase-forming particles,
b) heating the compact at a first elevated sintering temperature to form a metallic foam material having a sintered metallic skeleton structure with pores formed by selective removal of the space-holder particles, and
c) heating the metallic foam material at a second higher elevated temperature above a melting temperature of a eutectic phase formed between metals of the metallic particles and the eutectic phase-forming particles in the second region to form a liquid eutectic phase that wicks into, and densifies, walls of the metallic skeleton structure in the first region.

10. The method of claim 9 wherein the space-holder particles comprise fugitive non-metallic particles that are selectively removed when the compact is heated to the first elevated temperature so as to leave the pores.

11. The method of claim 10 wherein the fugitive non-metallic particles comprise NaCl or other salt particles.

12. The method of claim 9 wherein the second region resides above the first region

13. The method of claim 9 wherein the metallic particles comprise pre-alloyed powder particles.

14. The method of claim 9 wherein the metallic particles comprise pre-alloyed NiTi powder particles and the eutectic phase-forming particles comprise Nb particles.

15. A method of making a metallic foam material, comprising:
a) forming a compact comprising intermixed first metallic particles and second metallic particles that function both as space holder particles and as a eutectic phase-forming agent,
b) sintering the compact to form a metallic foam with a foam skeleton structure and a transient liquid phase which gets wicked into and densifies walls of the foam skeleton structure while also creating macro-pores in the space it liberates.

16. The method of claim 15 wherein solid state sintering is followed by transient liquid phase sintering during heating of the first and second metallic particles to elevated sintering temperature in multiple heating stages and/or using a controlled heating rate.

17. The method of claim 15 wherein the metallic particles comprise pre-alloyed powder particles.

18. The method of claim 17 wherein the metallic particles comprise pre-alloyed NiTi powder particles and the eutectic phase-forming agent comprises Nb particles.

19. The method of claim 18 wherein the eutectic phase comprises Ni, Ti, and Nb.

20. The method of claim 18 wherein the Nb particles comprise powder particles or discontinuous wire lengths.

21. A metallic foam comprising a sintered foam structure wherein pores are present throughout and wherein walls of the sintered foam structure are densified by a eutectic phase.

22. The foam of claim 21 wherein the pores impart a porosity of at least about 10% to the foam.

23. The foam of claim 21 wherein the foam structure comprises NiTi.

24. The foam of claim 21 wherein the eutectic phase comprises Ni, Ti, and Nb.
